(19) United States
(12) Patent Application Publication
(10) Pub. No.: US 2016/0014243 A1
(43) Pub. Date: Jan. 14, 2016

(54) CARRIER APPARATUS FOR MOBILE DEVICES

(71) Applicant: LUKE NATHANAEL SNOWDEN, GAUSE, TX (US)

(72) Inventor: LUKE NATHANAEL SNOWDEN, GAUSE, TX (US)

(21) Appl. No.: 14/797,119

(22) Filed: Jul. 11, 2015

Related U.S. Application Data
(60) Provisional application No. 62/023,846, filed on Jul. 12, 2014.

(51) Int. Cl. H04M 1/02; H04B 1/3877; H04M 1/04

(52) U.S. Cl. CPC H04M 1/0202; H04M 1/04; H04B 1/3877

(57) ABSTRACT

A carrier apparatus which may be affixed, removably or permanently, to a structure or surface, such that it is sufficiently accessible to the user for removably mounting one or more mobile devices. Various embodiments of the apparatus may be specifically configured for various devices, users, environments, and tasks.

### CROSS-REFERENCE TO RELATED APPLICATION

This is a non-provisional utility application claiming the priority of the U.S. provisional patent application No. 62/023,846 filed Jul. 12, 2014, which is herein incorporated by reference.

### FEDERALLY SPONSORED RESEARCH

Not Applicable

### SEQUENCE LISTING

Not Applicable

### BACKGROUND OF THE INVENTION

As mobile devices of various types serve an increasing number of functions and become increasingly convenient, even necessary, to maintain close at hand, multiple methods and apparatus that serve as carriers for transporting, mounting, or holding a mobile device have been devised, with varying utility and commercial success. Mobile devices that assist in such tasks as navigation and communication may often be particularly useful to a person driving a vehicle when mounted close at hand. In particular, an apparatus that mounts or holds a mobile device on a steering apparatus would offer especial advantages in many cases.

1. Field of the Invention

This invention relates to carrier apparatus for carrying devices. In particular, it is directed towards carrier apparatus adjustable to fit multiple devices and mount or hold mobile devices on structures or surfaces such that at least one mobile device is available to at least one user for use. In one particular application, this invention is directed in particular towards carrier apparatus adjustable to fit multiple devices and mount or hold mobile devices on steering apparatus such that at least one mobile device is available to at least one user while driving or while in the midst of other tasks or environments.

2. Description of the Related Art

A number of devices have been devised to hold or mount a mobile device on a steering apparatus. These devices may be broken down into several classes.

Navigation device and mobile device steering wheel clips, holders, or mounts are intended to be affixed to the steering wheel and hold a navigation device, mobile phone, tablet, or other such device. These mounts may strap on, clip on, tie on, or have at least one component that is permanently affixed to the steering apparatus. Current models varyingly suffer from any number of challenges including being difficult to attach, unwieldy, obtrusive, detrimental to driving, obstructive of integrated steering apparatus controls, flimsy, or difficult to remove. Additionally, many such apparatus may be designed specifically for one device, thereby limiting its versatility, or may be designed to act as a case and, thereby, preventing the user from keeping the mobile device in a different case of their own choice, such as a protective case, a decorative case, or a case that can be attached to a belt or pocket. Similar challenges are presented by mounts, holders, and carriers that are primarily intended for other devices, such as maps or cases.

Remote or integrated controllers seek to integrate some function of the mobile device directly into some steering apparatus accessory. Some directly integrate into the steering apparatus with some level of permanence, while others simply mount, more or less removably, a remote panel, such as a keypad. The challenges created by such apparatus include those mentioned above, as well as the additional expense and difficulty in apparatus with permanent integration. Additionally, those apparatus with a remote control necessarily limit full access to the device, and may cause the operator's attention to be drawn to the remotely controlled mobile device and further away from the driving task, significantly impacting safety of all concerned—driver, passengers, and others in the environment.

A device is needed to enable phone users to effectively have a navigation, communication, or other mobile device or system right in front of them without paying for a luxury vehicle or dedicated GPS system. A device is needed to promote safety by allowing people to keep their eyes on the road and both of their hands on the steering apparatus, while still being able to use a mobile device's functionality. Thus, a durable holder or mount is needed that enables a user to securely affix a mobile device to a steering apparatus such that it is useful, convenient, and safe. Various consumer feedback on current products falling into the classes related above indicates that inventions to meet these needs are clearly needed.

Specifically, multiple customers expressed the utility of current devices, such as steering wheel phone holders meant for speakerphone and navigation operations, but were dismayed with currently available products which, while initially found to be useful, failed quickly under normal use. Therefore, specific needs for a mobile device carrier apparatus include: accommodation of multiple phone sizes, ability to attach a mobile device in multiple positions, secure holding of mobile device, rugged performance, easy attachment and removal of mobile device, easy installation of holder and transfer between vehicles, and a relatively small and lightweight holder. Similar considerations hold for users in other environments who find it advantageous to mount mobile devices to various structures and surfaces.

### BRIEF SUMMARY OF THE INVENTION

Disclosed herein are apparatus for mounting mobile devices to structures or surfaces for advantageous use. Further disclosed are particular applications of the apparatus for carrying mobile devices on steering apparatus for use by vehicle drivers, or as adapted to other suitable tasks and environments.

### FIGURES

FIG. 1 is a perspective assembly view of one embodiment of the invention.

FIG. 2 is an exploded assembly view of the embodiment of the invention shown in FIG. 1.

FIG. 3 is a perspective assembly view of one embodiment of the invention.

FIG. 4A is an illustration of one embodiment of the invention.

FIG. 4B is an illustration of one embodiment of the invention.

FIG. 4C is an illustration of one embodiment of the invention.

FIG. 4D is an illustration of one embodiment of the invention.

FIG. 5 is an illustration of one embodiment of the invention.

FIG. 6A is an illustration of a steering apparatus attachment mechanism of various embodiments of the invention.

FIG. 6B is an illustration of a steering apparatus attachment mechanism of various embodiments of the invention.

FIG. 7A is an illustration of a steering apparatus attachment mechanism of various embodiments of the invention.

FIG. 7B is an illustration of a steering apparatus attachment mechanism of various embodiments of the invention.

### DETAILED DESCRIPTION

The following description of various embodiments of the invention, combined with the associated drawings, enables persons of ordinary skill in the art to both practice the preferred embodiment(s) of the invention, and to understand related applications and embodiments of the invention that may not be specifically set forth, but are encompassed by the specification and claims.

### General Embodiment

Embodiments disclosed herein relate to apparatus for mounting mobile devices to structures or surfaces for advantageous use. Further disclosed are particular applications of the apparatus for carrying mobile devices on steering apparatus for use by vehicle drivers, or as adapted to other suitable tasks and environments.

In a general embodiment, a carrier apparatus is affixed, removably or permanently, to a steering apparatus (one example of which would be an automobile steering wheel) or other suitable structure or surface, such that it is sufficiently accessible to the user for the intended use. In various embodiments, the carrier apparatus is of sufficiently durable construction to provide for sufficiently reliable continued fulfillment of its function.

Various embodiments of the carrier apparatus may be specifically configured for various devices, users, environments, and tasks.

Method of Use

To use an embodiment of this invention, a user will affix at least one component of the carrier apparatus to a suitable structure or surface. The carrier apparatus will then be used to removably mount or hold at least one mobile device on the structure or surface.

Specific examples and embodiments will serve to illustrate to persons skilled in the art the broader concepts disclosed.

Definitions

Following is a list of specific nomenclature used in reference to the invention disclosed herein and embodiments thereof. This list is provided as an aid to understanding the invention, and should be taken in the context of the full specification. In many cases, further embodiments and specific examples disclosed elsewhere in this document will further clarify the meaning, usage, and scope of a particular term.

Mobile Device

A mobile device may be any apparatus that is commonly used in a portable manner, or is often not used in a more or less permanent location. Such devices may include, but are not limited to, positioning and navigation devices (such as units with GPS positioning and navigation functions), mobile phones (including basic phones, multimedia phones, feature phones, and smartphones), laptops (including ultra-mobile personal computers), tablets, personal or enterprise digital assistants, calculators, pagers, game consoles, timers, cameras, media players, or any other device of a size and function that would allow for mounting to a steering apparatus and use thereon. Such use may include interacting with the mobile device, or may be as simple as keeping it conveniently accessible for further use upon parking or at a later time. Specific examples of mobile devices which may be used, representing only a few of the many possible types, are included in Table 1, with representative dimensions and weights.

Steering Apparatus

A steering apparatus is any apparatus used to direct the movement of a vehicle or other moveable object. While the most common embodiment is a generally circular ‘wheel,’ other embodiments are seen, such as steering handles used on airplanes, joysticks such as are used on helicopters or skid loaders, and handlebars such as are used on bicycles or luggage. In addition to specific steering apparatus, other suitable structures or surfaces vary widely and include tables, desks, chairs, counters, air-conditioner vents, dashboards, mirrors, windows, monitors, computers, shelves, lamps, framing, machinery, equipment, and some portion of living bodies such as human arms or legs.

User:

A user may be any being using or interacting with the carrier apparatus. Users may include a vehicle driver, operator, or passenger, an installer of a carrier apparatus on a steering apparatus, a person placing a mobile device(s) in a carrier apparatus or removing it therefrom, a person of any age using or interacting with a mobile device in a carrier apparatus, and a manmade apparatus performing any of the functions previously described in terms of persons. In other embodiments, users may also be animals or other non-human beings.

### Example Embodiments

Disclosed herein are examples of particular embodiments of one or more aspects of the invention. This list is by no means exhaustive, and is provided for the purpose of illustrating the scope of the invention and enabling practice of currently preferred embodiments of the invention.

In various embodiments, at least some portion of the carrier apparatus comprises a carrier mount which is removably affixed to the structure or surface. In variations of such embodiments, clips, straps, adhesive, friction, friction applied by compression or tension of some component(s) of the carrier apparatus in relation to the structure or surface, elastic bands, belts, buckles, clamps, hook-and-loop elements, tripods, stands, magnets, pads, moldable geometries, or other suitable affixing means may be employed.

In various embodiments, at least some portion of the carrier apparatus comprises a carrier mount which is permanently affixed to the structure or surface. In variations of such embodiments, affixing mechanisms may employ permanent adhesive, screws, bolts, or other suitable means.

In variations of such embodiments, the entire carrier apparatus may be permanently affixed; in other variations, a carrier mount portion of the carrier apparatus is permanently affixed to the steering apparatus, while a mobile device holding portion of the carrier apparatus is removably coupled to the attachment portion.

In various embodiments, the structure or surface is a steering apparatus. In various embodiments, the steering apparatus to which the carrier apparatus is affixed is a steering wheel, such as is typically used in automobiles.

In various embodiments, the carrier apparatus is configured to receive only one mobile device at any given time.

In various embodiments, the carrier apparatus is configured to receive more than one mobile device at any given time.

In various embodiments, the carrier apparatus is configured to allow a mobile device to rotate, to move, or both in relation to the structure or surface to which the carrier apparatus is affixed.

In various embodiments, the carrier apparatus is configured to allow at least one portion of the carrier apparatus to be detached with a mobile device. In variations of such embodiments, the detached portion of the carrier apparatus may be utilized for additional purposes, such as mounting to a belt or article of clothing, mounting to a purse, briefcase, or bag, standing on a table or desk, or other such purposes. In still other variations of such embodiments, the detached portion of the carrier apparatus may be utilized for additional purposes unrelated to mounting to a structure or surface, such as serving as a camera, media player, identification tag, microphone, loudspeaker, display, remote control component, wireless communication component, as a protective case, or other such purposes.

In various embodiments, the carrier apparatus is configured to serve as a connection point between at least one mobile device and at least one other device or system, such as a microphone, media system, speakers, navigation system, computer, or other devices or systems.

In various embodiments, the carrier apparatus is adjustable to receive more than one mobile device, such as different styles, geometries, functions, or sizes.

In various embodiments, the carrier apparatus is adjustable to be affixed to more than one steering apparatus, such as different styles, geometries, functions, or sizes.

In various embodiments, components of the carrier apparatus are constructed of materials specifically chosen for long service life, including materials such as glass-reinforced nylon, carbon fiber composites, aluminum, steel, titanium, Kevlar, or other suitable materials. In various embodiments, components of the carrier apparatus are constructed using any suitable manufacturing methods, examples of which may at times include injection molding, machining, casting, forging, additive manufacturing, filament deposition, subtractive manufacturing, or other suitable methods.

### DETAILED DESCRIPTION OF THE DRAWINGS

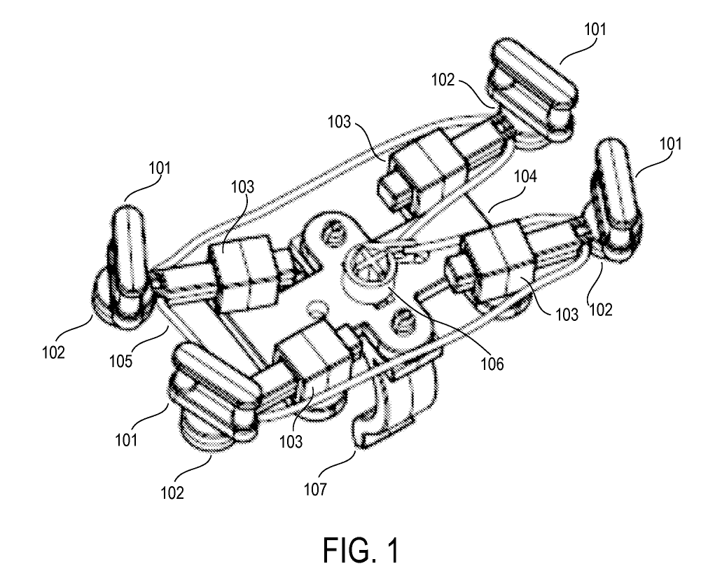

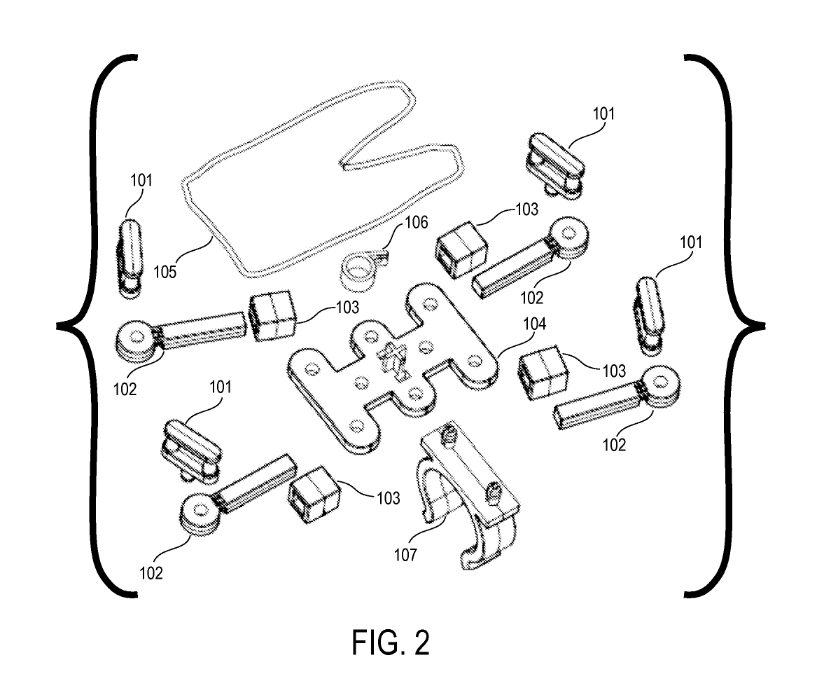

FIG. 1 and FIG. 2

These three dimensional illustrations depict one embodiment of the invention, such as is described in Example 1. FIG. 1 illustrates the embodiment as assembled, while FIG. 2 illustrates a breakout view of the individual components. In this embodiment, four contact structures 101 are provided in the shape of hooks to engage a mobile device. Contact structures 101 are rotatably attached to slidingly adjustable inner arms 102 and outer arms 103 via a snap fitting. Inner arms 102 slide inside outer arms 103, which are rotatably mounted to mounting structure 104 via snap fittings. Mount structure 104 is substantially plate-like.

This configuration allows inner arms 102 to adjust in length, allowing mounting many sizes of mobile device, by sliding through outer arms 103, which swivel on mounting structure 104 to allow the hooks 101 to engage the four corners of a mobile device. The contact structures 101 fit over the corners of a wide range of mobile devices, while covering a minimal surface area on the mobile device, thereby maximizing the access to various ports and controls of the mobile device.

An urging mechanism is provided comprising constant force spring 106 (which may be replaced with various other springs, as discussed hereafter) and flexible member 105, which passes through holes provided in each of inner arms 102. Spring 106 is mounted to mounting structure 104 and attached to flexible member 105 (may be single-stranded, such as a rubber band, ribbon, or monofilament fishing line, or multi-stranded such as cable or string), made of suitable material (metallic materials, such as steel cable, and non-metallic materials, such as nylon or Kevlar), thereby causing flexible member 105 to urge inner arms 102 inwards, bringing contact structures 101 into contact with the mobile device and aligning the contact structures 101 with the corners of the mobile device. Different geometries of contact structures and configuration of the arms may be used to engage different mobile devices and different points on mobile devices. For example, contact structures may be used to engage 3 corners, or 2 corners and a side, or a plurality of sides.

The carrier mount is comprised of clip 107 which is attached by two snap fittings to mounting structure 104, and allows the carrier apparatus to be mounted by snapping over a suitable structure, such as a steering wheel. Other structures may be advantageously used to replace or augment clip 107.

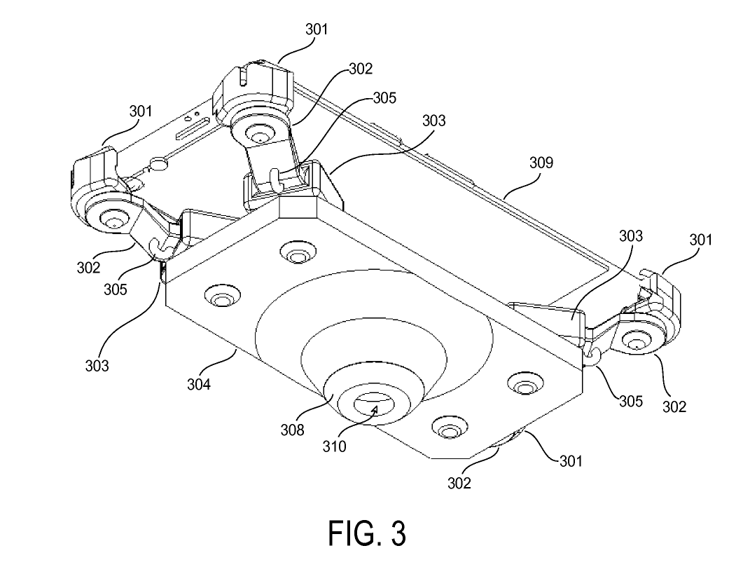

FIG. 3

This three-dimensional illustration depicts one embodiment of the invention, containing elements described in Example 1 and Example 7. In this embodiment, four contact structures 301 are shaped as hooks with a diamond-shaped base and two triangle-shaped walls connected to each other and the base, forming a tent-shaped hook that engages the corners of a mobile device 309 and secures it in the carrier apparatus by causing the hooks to be wedged over the corners of the mobile device as an urging mechanism. The urging mechanism is comprised of a flexible member such as flexible member 105 (FIG. 1), passing through loops 305 provided on inner arms 302, and configured to urge the contact structures 301 against the mobile device 309, such as by construction of flexible member 105 at least partially from elastic material, or by attachment of flexible member 105 to a spring located between the upper surface of mounting structure 304 and mobile device 309 (the spring being fixed only to flexible member 105 or also to one or more other structures). The inner arms 302 slide through outer arms 303, which are rotatably mounted by a snap fitting on mounting structure 304, which is substantially plate-like and is provided with a generally spherical cavity 308. Cavity 308 is at least partially open on the upper surface of mounting structure 304 (facing the back of mobile device 309), and is provided with a lower orifice 310 to allow a generally spherical object to be placed in cavity 309 and affixed to a carrier mount through lower orifice 310, such as is discussed in Example 7. Further, a cap or other suitable structure may be used to cover the upper opening of cavity 308, and the entire ball-and-socket type joint comprised of (a) cavity 308, (b) suitable generally spherical object, and (c) optional cap, may be provided with a rotation-resistance structure such as is discussed in Example 7.

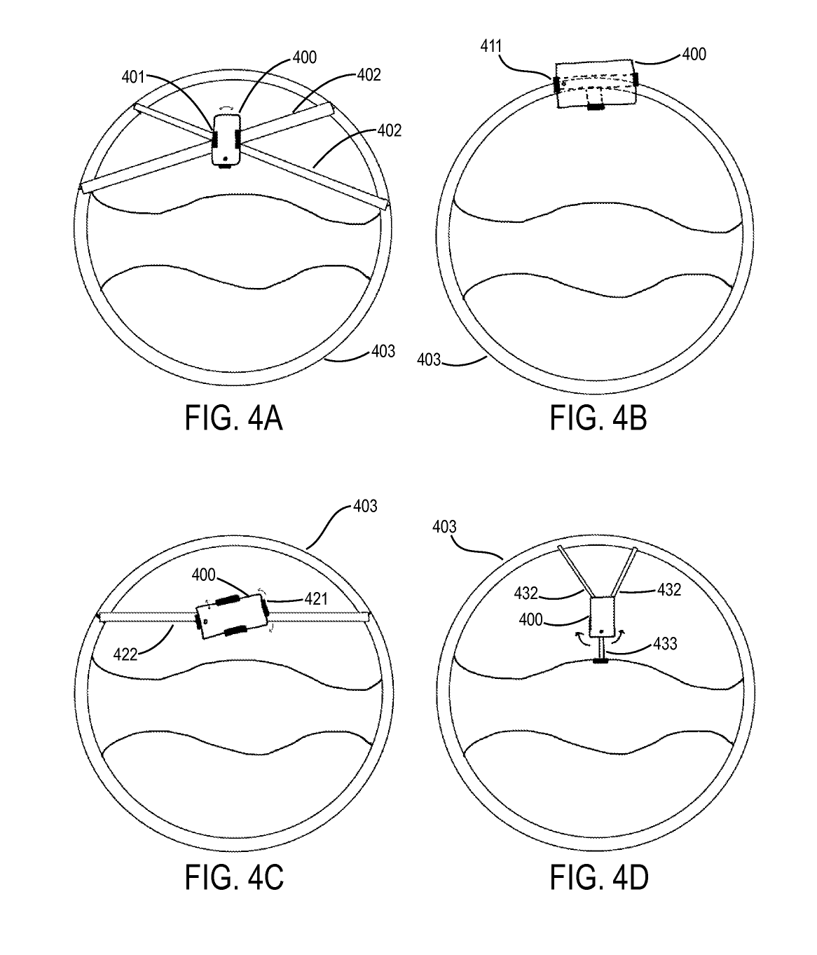

FIG. 4A, FIG. 4B, FIG. 4C, and FIG. 4D

These drawings of various embodiments of the invention illustrate variations which fall under the scope of this disclosure and claims, as described in Examples 4, 5, 2, and 3, respectively. In particular, they illustrate variations of attachment mechanisms which comprise part of the carrier mount of various embodiments and variations thereof.

In FIG. 4A, mobile device 400 and mobile device holder 401, shown here provided with three contact structures, are rotatably attached to two arms 402 which mount the carrier apparatus on a steering wheel or other structure or surface in a manner similar to that illustrated. In FIG. 4B, mobile device 400 and mobile device holder 411, shown here provided with three contact structures, are attached along some point of the outer rim of steering wheel 403, but may also be attached as discussed elsewhere, such as by a snap, clamp, or band, to another suitable object, whether it be, for example, a luggage handle, a computer screen, a table edge, a tripod, or a human arm. In FIG. 4C, mobile device 400 and mobile device holder 421 are rotatably attached to a single arm 422 which attaches to a structure, such as a steering wheel outer rim, as shown, such as by bands, clamps, clips, or snaps. Mobile device 400 and mobile device holder 421 may also be slidable in relation to arm 422, enabling the mobile device to be positioned along the arm. In FIG. 4D, mobile device 400 is rotatably mounted via a mobile device holder to upper arms 432 and lower arm 433 which are in compression against one another or a central structure or structures such that the arms 432 and arm 433 are effectively wedged into a space, such as between the rim and center of a steering wheel, as shown, and thereby provide a substantially secure mount for mobile device 400.

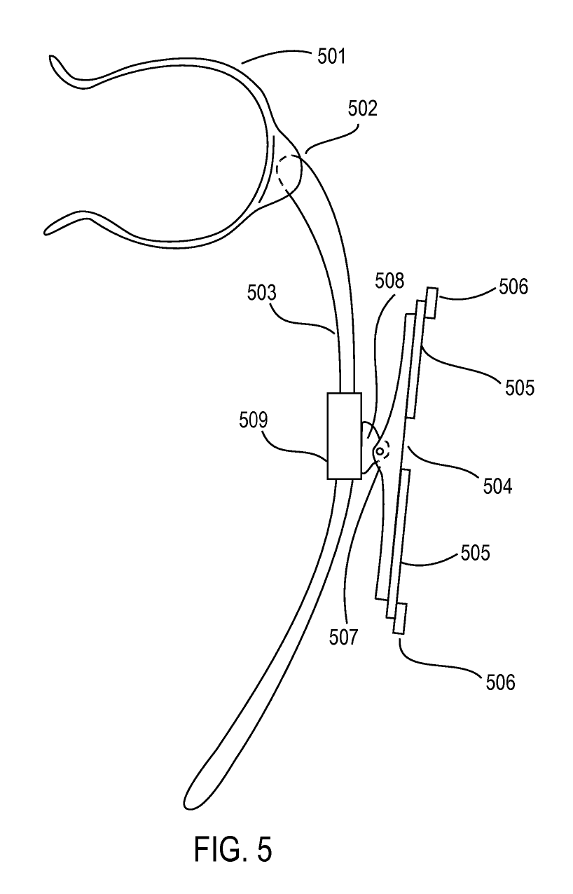

FIG. 5

This figure illustrates an embodiment of the invention, such as is described in Example 6. A carrier mount is comprised of (a) snap 501, which is configured to snap over a desired structure, such as a handle or steering wheel, and may be replaced with another suitable surface or structure engagement apparatus; (b) hinge 502 provided with one degree of freedom, (c) stalk 503, (d) sleeve 509, (e) optional hinge 508, and (f) hinge 507. The carrier mount, in the depicted variation of the embodiment, engages the outer rim of a steering wheel or other suitable structure with snap 501, while hinge 502 allows the stalk 503 to swing down and rest on the center of the steering wheel or on any suitable structure. The single degree of freedom in hinge 502 prevents stalk 503 (which is shown curved for aesthetic purposes, but may take any desirable configuration, including cross-sections or profiles which are simple or complex, geometric or organic, and constant or varying) from swinging side to side relative to the structure the carrier apparatus is mounted on. Sleeve 509 is configured to slide at least partway along stalk 503 and may rotate about stalk 503 either by inherent geometry (such as having a round interior mated to a round stalk) or by being provided with a suitable rotation mechanism (such as a two-part bushing wherein an inner part slides along stalk 503 and an outer part rotates about the inner part). A mobile device mounted in the carrier apparatus may then be advantageously positioned by sliding the mobile device holder comprised of contact structures 506, arms 505, and mounting structure 504, along stalk 503. An optional hinge 508 may supplement or replace the rotation of sleeve 509 about stalk 503. Hinge 507 allows mounting structure 504 to be tilted in at least one direction, thereby allowing the user to tilt the mobile device to an advantageous position, such as to reduce glare or make audible driving directions more clear. A plurality of adjustable arms 505 are rotatably mounted to mounting structure 504 (which is substantially plate-like), and contact structures 506 are rotatably mounted to arms 505. At least one mobile device is mounted to the carrier apparatus as described elsewhere herein.

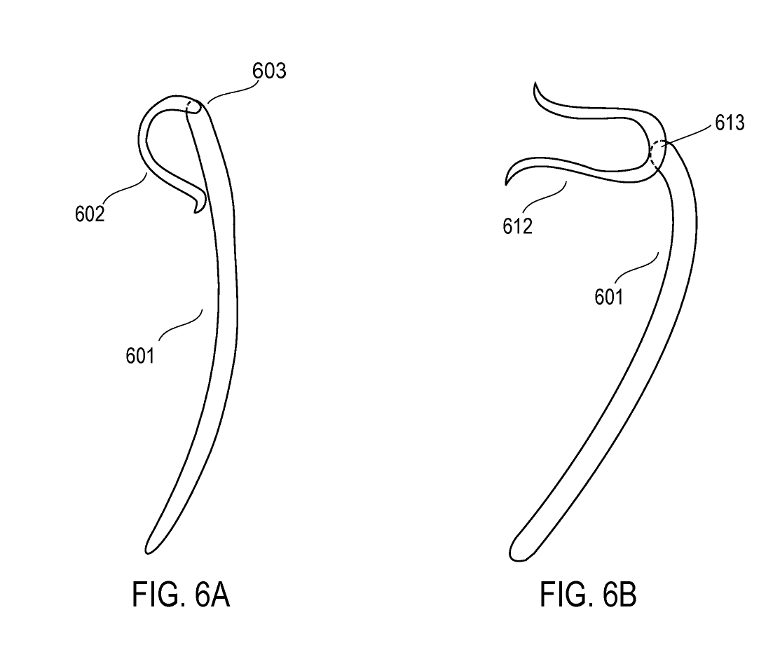

FIG. 6A and FIG. 6B

These drawings of various embodiments of the invention illustrate variations of attachment mechanisms as described in Example 6. In FIG. 6A, hook 602 is connected to stalk 601 by hinge 603. In one particular variation, the mechanism is configured for hook 602 to engage the outer rim of a steering wheel, and may be provided with a rotation-resistance mechanism as discussed elsewhere herein, such as an elastomeric pad, at least partial construction of hook 602 or stalk 601 from elastomeric material, a textured surface, another suitable rotation-resistant mechanism, or any combination thereof. Hinge 603 may be spring-loaded in order to urge hook 602 to close over the steering apparatus and urge the bottom end of stalk 601, which may take on a variety of configurations as discussed elsewhere such as in regard to FIG. 5, to rest against the center of the steering wheel. Hinge 603 may alternatively or also be provided with a rotation-resistance mechanism such as a textured surface or elastomeric pad. In some variations, the rotation-resistance mechanism is configured to allow the user to actively engage or disengage it to allow freer movement of the stalk during positioning. In some variations, hinge 603 may be comprised of a mechanically compliant structure non-rotatably attached to snap 602 and stalk 601. In such a configuration, the rotation is provided by the inherent mechanical compliance of the structure and a rotation-resistance mechanism is inherently provided by the modulus of elasticity of the structure: the firmer the material, the greater the resistance to rotation.

In FIG. 6B, a similar structure is illustrated, with stalk 601 being connected to snap 612 via hinge 613. In this illustration, snap 612 is configured to snap over a structure such as a steering wheel rim, luggage handle, bicycle handlebar, table, desk, computer, or machine. Further, snap 612 may be one or more pieces. Hinge 613, like hinge 603, may be spring-loaded, may be integral to stalk 601 and snap 612, and may be provided with a rotation-resistance mechanism. Hinge 613 may further be configured to urge together multiple parts of snap 612.

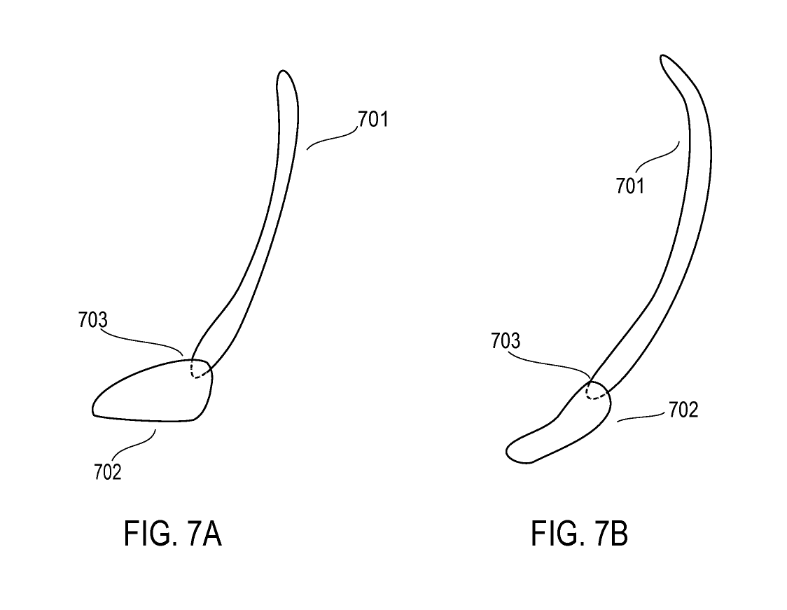

FIG. 7A and FIG. 7B

These drawings of various embodiments of the invention illustrate variations of attachment mechanisms as described in Example 6. Stalk 701 is attached to foot 702 by joint 703. FIG. 7A depicts joint 703 as a hinge, spring-loaded in particular variations, similar to hinge 603 in FIG. 6A and FIG. 6B. FIG. 7B depicts joint 703 as an at least partially mechanically compliant, rigidly-affixed connection between stalk 701 and foot 702. In some variations joint 703 may be integral to stalk 701 and foot 702, while in others it may be a separate structure.

The configurations illustrated in FIG. 7A and FIG. 7B may be combined with attachment mechanisms such as those shown in FIG. 6A and FIG. 6B, to allow the bottom end of stalk 601 in FIG. 6A and FIG. 6B to more positively engage a structure or surface, such as the center of a steering wheel by wedging foot 702 against an advantageous surface or structure, such as the top of the center of a steering wheel. Further, foot 702 is configured in some variations to resist slippage, such as by addition of a mechanically compliant pad or being at least partially constructed from mechanically compliant material or being provided with a textured surface.

### EXAMPLES

The preceding disclosure will be further understood by the use of several examples of specific embodiments of apparatus and methods contemplated by the inventor, which are disclosed solely for illustrative purposes, and should not be construed as limiting in any way. Further examples of other embodiments of the invention will readily present themselves to persons skilled in the art.

### Example 1

In one embodiment, a carrier apparatus is:
a) Mounted directly to a steering apparatus (such as the outer rim of a steering wheel) by a clip (acting as a carrier mount), reducing the required size and adjustability which would be needed to fasten a device across a section of the wheel, which would vary in size between steering apparatus,
b) Conducive to providing multiple positions for a mobile device, due to the simpler carrier mount,
c) Durable, with a smaller carrier mount than other designs and so less prone to failure and easy to use. In particular variations, the way in which the mobile device is held in the carrier apparatus secures all four corners of the mobile device. In various embodiments, the mobile device is held in the carrier apparatus by a plurality of contact structures.

In a variation of this embodiment, the carrier apparatus is comprised of seven distinct parts (multiples are used of some distinct parts), as can be seen in FIG. 1 and FIG. 2. In particular, this particular variation seeks to maximize ease of use by employing a clip attachment to the steering apparatus and spring loaded arms with swivel corner brackets, enabling the carrier apparatus to automatically adapt to a wide range and geometries of mobile device sizes with no separate adjustments required of a user. In yet other variations, the carrier apparatus is configured similar in function to the illustrations in FIG. 1 and FIG. 2, but is comprised of more or less than seven distinct parts. Some of the said variations incorporate multiples of one or more distinct parts, while others of the said variations incorporate no multiples. Elements of such variations are also depicted in FIG. 3.

### Example 2

In one embodiment, a carrier apparatus is comprised of an arm which is mounted across a steering apparatus, such as a steering wheel. The arm is mounted in at least two places to the steering apparatus, for example by hook-and-loop straps on both ends of the arm and strapped to outer circle of a steering wheel.

A mobile device, such as a cell phone or GPS unit, is rotatably mounted on the arm by a mounting unit comprised of sliding brackets, such as four brackets, each securing the mobile device approximately in the middle of each side of a four-sided mobile device.

A particular variation of this embodiment is depicted in FIG. 4C.

### Example 3

In one embodiment, a carrier apparatus is comprised of multiple arms mounted to various points on a steering apparatus, such as a steering wheel. In one variation, as depicted in FIG. 4D, three arms are employed to mount the carrier apparatus on a steering wheel. Two arms are affixed by a suitable means to the left and right, respectively of the center of the inside top of the outer ring of the steering wheel, while the third arm is affixed by a suitable means to the top of the center portion of the steering wheel.

Suitable means of affixing the various arms may include straps, such as discussed in Example 1, friction (e.g. by an interference fit of the arms in their affixing locations, friction possibly being increased in some variations by means such as elastomeric pads), or adhesive. The various arms need not all be affixed using the same means.

A mobile device is rotatably mounted on the arms by means similar to those discussed in Example 2. In a particular variation, such as is shown in FIG. 4D, the rotatable mounting means is configured to always keep the mobile device in a preferred orientation (such as keeping a feature phone vertical).

### Example 4

In one embodiment, a carrier apparatus is comprised of two or more arms mounted across a steering apparatus, such as a steering wheel, in a manner similar to that discussed in Examples 1 and 2.

The mobile device is mounted on the arms by means similar to those discussed in Examples 1 and 2. In a particular variation, the brackets are adjusted to receive a particular mobile device, and sufficient brackets are used to allow the mobile device to be dropped into the mobile device holder, as shown in FIG. 4A. In a particular variation, such as is also shown in FIG. 4A, a rotatable mounting means is employed such as is discussed in Example 3.

### Example 5

In one embodiment, a carrier apparatus is comprised of at least one carrier mount which attaches to some portion of a steering apparatus, such as a solid or articulating clip or clamp which attaches to the outer ring of a steering wheel, a particular variation of which is discussed in Example 1 and depicted in various figures relating to Example 1.

The mobile device is mounted on the carrier mount either in a fixed orientation, or rotatably, by means similar to those discussed in previous Examples 1-4. A general variation of this embodiment is illustrated in FIG. 4B.

### Example 6

In one embodiment, the mobile device is mounted to the carrier apparatus using a suitable attachment means, such as is discussed in previous Examples 1-5. The carrier apparatus, such as is shown in FIG. 10, is affixed to a steering apparatus, such as a steering wheel. The attachment mechanism for affixing the carrier apparatus to the steering apparatus is comprised of a curved arm which is typically oriented vertically on the steering apparatus, and affixed to the steering wheel by a mechanism, such as a clip or clamp, attached by a hinge or other rotatable joint at the top of the arm, which may be attached to a suitable portion of the steering apparatus, such as the top of the outer ring of a steering wheel.

One particular attachment mechanism, being attached to the curved arm by a hinge joint with one degree of freedom, and being made of a sufficiently flexible material to allow the mechanism to be snapped onto the steering mechanism, is shown in FIG. 5. Other configurations are also encompassed, two of which are partially depicted in FIG. 6A and FIG. 6B. These configurations include a hinged clamp with one clamping arm (FIG. 6A), or two clamping arms (FIG. 6B), spring-loaded clamps and clips, clips or clamps made of flexible material, and clips or clamps which are secured by a bolt or screw mechanism.

The bottom of the curved arm rests on some portion of the steering apparatus, such as the top of the center portion of a steering wheel. As shown in FIG. 5, in particular embodiments, the curved arm terminates simply, with no additional structure. In various embodiments, the curved arm is held in the desired position by the top attachment mechanism, which in some embodiments resists rotation around its attachment point, and resists rotation of the curved arm about the attachment point of the top of the curved arm to the top attachment mechanism, thereby holding the bottom of the curved arm against its contact point on the steering apparatus.

Other configurations are also encompassed, two of which are depicted in FIG. 7A and 7B. These configurations include a bottom mechanism comprised of a hinged foot (FIG. 7A) or a fixed, flexible foot (FIG. 7B) attached to the bottom end of the curved arm. Such feet may be spring loaded or rely solely on mechanical compliance of the material. Such feet are configured in some embodiments to apply pressure to the contact point of the bottom end of the curved arm with the steering apparatus, thereby affixing the carrier apparatus using friction, such as by ‘wedging’ the curved arm between the top attachment mechanism and the bottom attachment mechanism.

In one particular variation, shown in FIG. 5, the mobile device holder is attached with a hinge and sleeve to the curved arm such that the mobile device holder may be tilted up and down on the hinge, and may be rotated left and right around the curved arm. Additionally, the mobile device holder may be positioned higher or lower by sliding the sleeve up and down on the curved arm. In another variation, the mobile device holder is attached to the curved arm via a ball joint. In still other variations, the curved arm may be straight, serpentine, segmented, or any other suitable configuration.

### Example 7

In one embodiment:
(a) the carrier apparatus is affixed to a steering apparatus or other suitable surface or structure by a carrier mount; in some variations, the carrier mount affixes to a steering apparatus (such as a steering wheel or luggage handle) via a spring-loaded or latchable clamp; in other variations, the carrier mount affixes to a surface (such as a table or window) using a clamp or stand; in other variations, the carrier mount affixes to a structure (such as a human arm) using an elastic or hook-and-loop band;
(b) the carrier mount is attached to a generally spherical object (such as the ball of a ball joint) although some portion of the sphere may be truncated or adapted to adjacent geometries;
(c) the ball is located inside a generally spherical cavity (such as the socket of a ball joint) although some portion of the spherical cavity may be truncated or adapted to adjacent geometries;
(d) the spherical cavity is attached to or integral to some portion of the mechanism for mounting the mobile device;
(e) the mobile device is mounted by engaging a plurality of contact structures relocatable in relation to the carrier apparatus;
(f) a retraction mechanism such as a spring (extension, compression, meander, roll, constant force, torsion, sheet metal, stamped, elastic, or other suitable types) urges the contact structures in a direction suitable for engaging the mobile device.

In particular variations of this embodiment, a latchable clamp is employed to affix the carrier apparatus to the steering apparatus or other structure or surface. In some variations, the latchable clamp is latched by a thumb-type screw with a thread geometry suitable for latching in one revolution of the screw or less.

In particular variations of this embodiment, the spherical object is a ball with at least one flat end and suitably geometry (such as holes, slots, bosses, threads, ways, and grooves) for mating with corresponding geometry of the structure for affixing the carrier apparatus to the steering apparatus. In some variations, the spherical object is made of a material with some amount of mechanical compliance to increase friction and, thereby, resist rotation, between the spherical object and spherical cavity in order to reduce unwanted movement of the mounted mobile device. In some variations, a rotation resistance structure such as a pad of suitable thickness, made from a material with some amount of mechanical compliance, is situated to engage the surface of the spherical object while the spherical object is inside the spherical cavity, thereby reducing movement of the spherical object relative to the spherical cavity.

In particular variations, a rotation resistance structure is provided, comprised of a spring or elastomeric pad situated inside a cap of suitable geometry such that the pad is still not flush or below the surface of the cap. The cap is affixed to the top of a mounting structure (such as a plate with a spherical boss) with a spherical cavity integral or attached to it, said spherical cavity opening to the side of the structure facing the mobile device when mounted and also having an orifice on the side of the mounting structure facing the carrier mount (mechanism for affixing the carrier apparatus to the structure or surface such a steering apparatus). The spherical object is a ball with one flat side, to which the carrier mount is attached. The ball is made from any suitable material, including rigid and mechanically compliant materials. This ball is deposited into the spherical cavity before the cap or the mechanism for affixing the carrier apparatus are attached. Once assembled, the spherical object and cavity act substantially as a ball and socket joint, and the spring or elastomeric pad embedded in the cap acts to increase friction between the ball and the pad or spring and between the ball and cavity, enabling the user to position the mobile device while mounted while resisting unwanted rotation of the joint while the user is not positioning the mobile device.

In further particular variations, the rotation resistance structure is comprised of a textured surface, whether integral to the joint, deposited within it, or affixed to it. Examples of textured surfaces include various 3-dimensional patterns formed into a part; serrations, grooves, bumps, or ridges with or without matching serrations, grooves, bumps, or ridges on a mating part(s); inherent texture from normal material or manufacturing properties of a part; or grains or other particles or objects deposited on or embedded into a surface. Further, various rotation-resisting elements may be combined together in the rotation resistance structure, such as a spring pressing an elastomeric or textured surface against the spherical object or cavity.

In one particular variation, the rotation-resistance structure is comprised of an elastomeric pad placed in compression (acting as an integral spring) between the spherical object against the cavity and configured such that pressing down on the mobile device in the mobile device holder relieves at least part of the compression on the elastomeric pad and reduces the resistance to rotation while the user repositions the mobile device in the mobile device holder relative to the carrier mount and structure or surface to which the carrier apparatus is mounted. Once the user ceases to press down, the compression on the elastomeric pad substantially returns to the previous higher level and again increases resistance to rotation in order to hold the mobile device mounted in the mobile device holder substantially still relative to the carrier mount and structure or surface.

In particular variations of this embodiment, the mobile device is mounted to the carrier apparatus by four contact structures, specifically ‘hooks,’ which each engage one of the four corners of the mobile device by a cupping or hooking over the corner. In more particular variations the hooks have a generally diamond-shaped base, the top of which contacts the back of the mobile device, and two generally triangular shaped walls connected directly or indirectly to each other and the base to form a generally tent-shaped structure. In more particular variations, the hook is made at least partially from material with some level of mechanical compliance to allow some level of shaping of the hook to the geometry of the mobile device corner or to enhance the grip of the hook on the mobile device by increasing friction, or both.

The hooks are rotatably mounted to variable-length arms which are rotatably mounted to the plate or other structure described previously in this embodiment. In variations of this and other embodiments, the rotatable attachment of the contact structures (such as hooks) and adjustable arms may be provided by mechanically compliant material, such that a contact structure and arm are one piece, formed from a mechanically compliant material that allows the contact structure to rotate relative to the arm. In such situations, the arm may deform to provide all or part the rotation. Further, in variations of this and other embodiments, the adjustable arms may be attached together or to one or more other structures, such as a plate, and may be formed continuously with each other or one or more other structures, such that at least part of the resulting structure is comprised of mechanically compliant material that allows the arms to rotate by deformation of some portion of the resulting structure.

In particular variations, the arms are urged shorter by a flexible member (examples of which include cable, string, rope, ribbon, and bands and may be comprised of elastic or non-elastic materials including rubber, Kevlar, steel, copper, and polyurethane) passing through each arm and attached to a spring, thereby applying a retaining force on the mobile device. In some variations, the spring is an extension spring mounted to either the cap or the mounting structure previously described in this example. In alternative variations, the spring is a constant-force spring. In still other alternative variations, the arms are urged shorter by a gear system such as a rack and pinion setup, driven by a torsion spring or other suitable structure. In still other alternative variations, the arms are urged inward by the user and a lock is engaged by the user to retain the arms in the desired position. The lock may be normally unengaged and requiring positive action from the user to engage it for locking the arms, or may be normally engaged and require positive action from the user to disengage it for movement of the arms.

Certain elements of these variations may be omitted or adapted as seen fit by persons skilled in the art, or may be incorporated into other variations and embodiments described herein.

The invention claimed has been herein disclosed sufficiently for persons skilled in the art to comprehend and practice. The various embodiments, examples, and illustrations disclosed herein, while representing the best and various alternative modes of carrying out the invention as currently contemplated by the inventor, are by no means limiting or exhaustive, but serve as an aid to comprehending the full nature and scope of the invention. Various other embodiments will become apparent which fall within the scope of this disclosure and claims, including various combinations and permutations of the aforementioned examples.

TABLE 1
EXAMPLE MOBILE DEVICES

| | Size [inches] | Weight | |
|---|---|---|---|
| Example Device | (width × height × depth) | [ounces] | Type |
| Garmin-nuvi 50LM | 3.5 × 5.5 × ⅝ | 7.8 | GPS |
| TomTom-Start 50M | 3.5 × 5.25 × 9/10 | 8.9 | GPS |
| iPhone 5S | 4.87 × 2.31 × 0.30 | 3.95 | Smartphone |
| Galaxy S5 | 5.59 × 2.85 × 0.31 | 5.11 | Smartphone |
| iPad mini | 7.87 × 5.3 × 0.258 | 11.04 | Tablet |
| iPad Air with | 9.4 × 6.6 × 0.29 | 16.8 | Tablet |
| Wi-Fi + Cellular | | | |
| Samsung Galaxy | 11.64 × 8.03 × 0.31 | 26.57 | Tablet |
| Note Pro 12.2 | | | |
| Kindle Paperwhite | 6.7 × 4.6 × 0.36 | 7.6 | Tablet |
| 3G | | | |

NOTE:
Many devices will fulfill the function of multiple types. These are represented as belonging in one representative type, which should not be construed to exclude them from other types. For example, a smartphone may, through various included or optional software and hardware components, function as a calculator (computational device), media player and GPS/navigational device, among other things, but is only listed above as a smartphone.

I claim:

1. A carrier apparatus for mounting at least one mobile device to a desired surface or structure, such that said carrier apparatus does not employ a one-piece elastic band for securing said device to said carrier apparatus, does not consist of grips constrained to move in a single line of approach relative to said carrier apparatus, and does not rely on elastic bands to secure said mobile device to said carrier apparatus;
wherein said carrier apparatus is comprised of a mobile device holder and a carrier mount;
said mobile device holder comprised of a plurality of adjustable arms, said arms rotatably mounted to said carrier mount; and a plurality of mobile device contact structures, said contact structures rotatably mounted to said adjustable arms.

2. The apparatus of 1, wherein said carrier mount is comprised of at least one of: at least one clip which may be snapped over the outer ring of a steering apparatus, at least one strap which may be strapped over said outer ring, at least one clamp which may be clamped over said outer ring, and any combination thereof.

3. The apparatus of 1, wherein said adjustable arms are retracted by an urging mechanism.

4. The apparatus of 3, wherein said urging mechanism is comprised of at least one of: a flexible member passing through at least one of said adjustable arms, said flexible member being attached to at least one spring, said spring being attached to said carrier apparatus; an elastic member passing through at least one of said adjustable arms; and any combination thereof.

5. The apparatus of 4, wherein said flexible member is comprised of at least one of:
metal, Kevlar, and any combination thereof.

6. The apparatus of 3, wherein said mobile device holder is further comprised of four (4) said adjustable arms and four (4) said contact structures, each of said contact structures rotatably affixed generally to the outer end of one of said adjustable arms.

7. The apparatus of 3, wherein said contact structures possess the general shape of at least one of: a hook, a clip, two columns with a beam connecting the top and bottom of both columns, a generally diamond shaped base at least indirectly connected to two generally triangular shaped walls further at least indirectly connected to each other to form a generally tent-shaped structure, and any combination thereof.

8. The apparatus of 7, wherein said contact structure is comprised of at least partially mechanically compliant material.

9. The apparatus of 8, wherein said contact structures are comprised of at least one of: natural rubber, polyurethane, silicone, nylon, and any combination thereof.

10. The apparatus of 1, wherein said carrier mount is rotatably joined to said mobile device holder by a ball-and-socket type joint.

11. The apparatus of 10, wherein said joint contains at least one rotation resistance structure configured to provide rotation resistance to said joint, said rotation resistance structure being comprised of at least one of: at least one portion of a generally spherical object forming the ball of said joint, at least one portion of a generally spherical cavity forming the socket of said joint, a pad embedded in said socket, a pad affixed to said socket, a pad embedded in said ball, a pad affixed to said ball, a pad embedded in a cap covering at least one said orifice of said socket, a pad affixed to a cap covering at least one orifice of said socket, a liner lining at least one portion of said socket, a liner lining at least one portion of said ball, and any combination thereof,
said rotation-resistance structure being comprised of at least one of: a material at least partially mechanically compliant, a textured surface, a spring, and any combination thereof.

12. The apparatus of 11, wherein at least one of: said carrier mount and said mobile device holder are comprised of at least one of: metal, glass-reinforced nylon, and carbon-fiber reinforced material, and said mechanically compliant material is comprised of at least one of: natural rubber, polyurethane, silicone, nylon, and any combination thereof.

13. The apparatus of 1, wherein said mobile device holder is configured to receive one said mobile device, said carrier mount is a lockable clamp, and said desired surface or structure is a steering apparatus.

14. The apparatus of 1, wherein said mobile device is at least one of: positioning devices, navigation devices, GPS-enabled personal digital assistant, map-enabled phone, map-enabled laptop, map-enabled tablet, and any combination thereof.

15. The apparatus of 1, wherein said mobile device performs at least the function of a telephone.

16. The apparatus of 1, wherein said mobile device performs at least the function of a media player.

17. The apparatus of 1 wherein said carrier apparatus is comprised of an arm with at least a top attachment mechanism which may be affixed to some portion of said steering apparatus, and a mobile device holder, coupled to said arm, which receives said mobile device.

18. A carrier apparatus for mounting at least one mobile device to a desired surface or structure, such that said carrier apparatus does not employ a one-piece elastic band for securing said device to said carrier apparatus, does not consist of grips constrained to move in a single line of approach relative to said carrier apparatus, and does not rely on elastic bands to secure said mobile device to said carrier apparatus;
said carrier apparatus comprised of a carrier mount and a mobile device holder, wherein said mobile device holder is comprised of a plurality of rotatable, adjustable arms; a plurality of rotatable mobile device contact structures, and an urging mechanism; said mobile device contact structures being sufficiently rigid to allow a user to mount said mobile device to said mobile device holder using one hand by engaging at least one of said contact structures with said mobile device and subsequently engaging remaining said contact structures until all contact structures are engaged.

19. The apparatus of 18, wherein each of said adjustable arms is comprised of at least two parts which are slidingly adjustable relative to each other, one of said parts being rotatably mounted to a mounting structure;
and said urging mechanism is comprised of a flexible member passing through each of said adjustable arms and at least one of: a spring mounted directly to said mounting structure, a spring mounted indirectly to said mounting structure, an unmounted spring, and any combination thereof;
said urging mechanism configured such that said contact structures come into contact with and engage said mobile device when said mobile device is mounted.

20. The apparatus of 19, wherein said mounting structure is connected to said carrier mount by a joint;
said mounting structure is substantially plate-like and is provided with a substantially spherical cavity, said cavity being provided with at least two orifices;
said carrier mount is comprised of a substantially spherical object within said cavity, said object being affixed to a means for mounting said object to at least one of: a steering apparatus, a surface, a structure, and any combination thereof, where said object is affixed to said mounting means through at least one of said orifices;
at least one of said orifices is sufficiently large for said object to pass through into said cavity;
and said joint is comprised of said cavity, said object, and a mechanically compliant rotation-resistance structure configured to provide rotation-resistance between said cavity and said object, said rotation-resistance structure being comprised of at least one of: at least one portion of said object, at least one portion of said cavity, a pad embedded in said cavity, a pad affixed to said cavity, a pad embedded in said object, a pad affixed to said object, a pad embedded in a cap covering at least one said orifice of said cavity, a pad affixed to a cap covering at least one said orifice of said cavity, a liner lining at least one portion of said cavity, a liner lining at least one portion of said object, and any combination thereof, said rotation-resistance structure being comprised of at least one of: a material at least partially mechanically compliant, a textured surface, a spring, and any combination thereof.
